(19) United States
(12) Patent Application Publication
(10) Pub. No.: US 2012/0092444 A1
(43) Pub. Date: Apr. 19, 2012

(54) SYSTEM AND METHOD FOR PROVIDING VIDEOMAIL IN A NETWORK ENVIRONMENT

(75) Inventors: David J. Mackie, San Jose, CA (US); Shamim Pirzada, San Jose, CA (US); Neil Joshi, Milpitas, CA (US); Kristen Marie Robins, Sunnyvale, CA (US); Binh Don Ha, Fremont, CA (US); Jaime F. Guerrero, San Francisco, CA (US)

(73) Assignee: Cisco Technology, Inc.

(21) Appl. No.: 12/907,914

(22) Filed: Oct. 19, 2010

(51) Int. Cl. H04N 7/15

(52) U.S. Cl. 348/14.12

(57) ABSTRACT

A method is provided in one example and includes receiving a request to establish a video session between a first user and a second user. The request is sent by the second user by dialing an identifier string associated with the first user. The method also includes evaluating whether the first user has accepted the request. If the first user has not accepted the request over a designated interval, then the second user is directed to an element configured for recording a videomail message for access by the first user. The method also includes identifying the first user has accepted the request, and establishing the video session between the first user and the second user.

### TECHNICAL FIELD

This disclosure relates in general to the field of communications and, more particularly, to providing videomail in a network environment.

### BACKGROUND

Video services have become increasingly important in today's society. In certain architectures, service providers may seek to offer sophisticated video conferencing services for their end users. The video conferencing architecture can offer an “in-person” meeting experience over a network. Video conferencing architectures can deliver real-time, face-to-face interactions between people using advanced visual, audio, and collaboration technologies. The ability to optimize video communications provides a significant challenge to system designers, device manufacturers, and service providers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system for providing a video session in a network environment in accordance with one embodiment of the present disclosure;

FIG. 2 is a simplified block diagram illustrating one example implementation of certain components associated with the system;

FIG. 3 is a simplified block diagram illustrating one example implementation of network traffic management associated with the system;

FIG. 4 is a simplified block diagram illustrating another example implementation of network traffic management associated with the system;

FIG. 5 is a simplified block diagram illustrating one example implementation of a videomail server associated with the system; and

FIGS. 6A-10 are simplified flow diagrams illustrating various potential operations associated with the system.

### DETAILED DESCRIPTION OF EXAMPLE EMBODIMENTS

### Overview

A method is provided in one example and includes receiving a request to establish a video session between a first user and a second user. The request is sent by the second user by dialing an identifier string associated with the first user. The method also includes evaluating whether the first user has accepted the request. If the first user has not accepted the request over a designated interval, then the second user is directed to an element configured for recording a videomail message for access by the first user. The method also includes identifying the first user has accepted the request, and establishing the video session between the first user and the second user.

In more specific implementations, the video session is rendered on a display that is configured to concurrently display television programming for the first user. In other examples, the method can include initiating a particular call to a particular user, where the first user initiates the particular call using a smartphone. The particular call can be transitioned to a particular video session on a display configured to concurrently display television programming for the first user.

Privacy settings can be accessed in order to determine whether to establish the video session between the first user and the second user. The method can also include recording a video message; selecting a particular identifier string associated with a particular user; and communicating the video message to a destination associated with the particular user. The destination for the video message can be a uniform resource locator (URL) address, a Webcam associated with a particular user.

### Example Embodiments

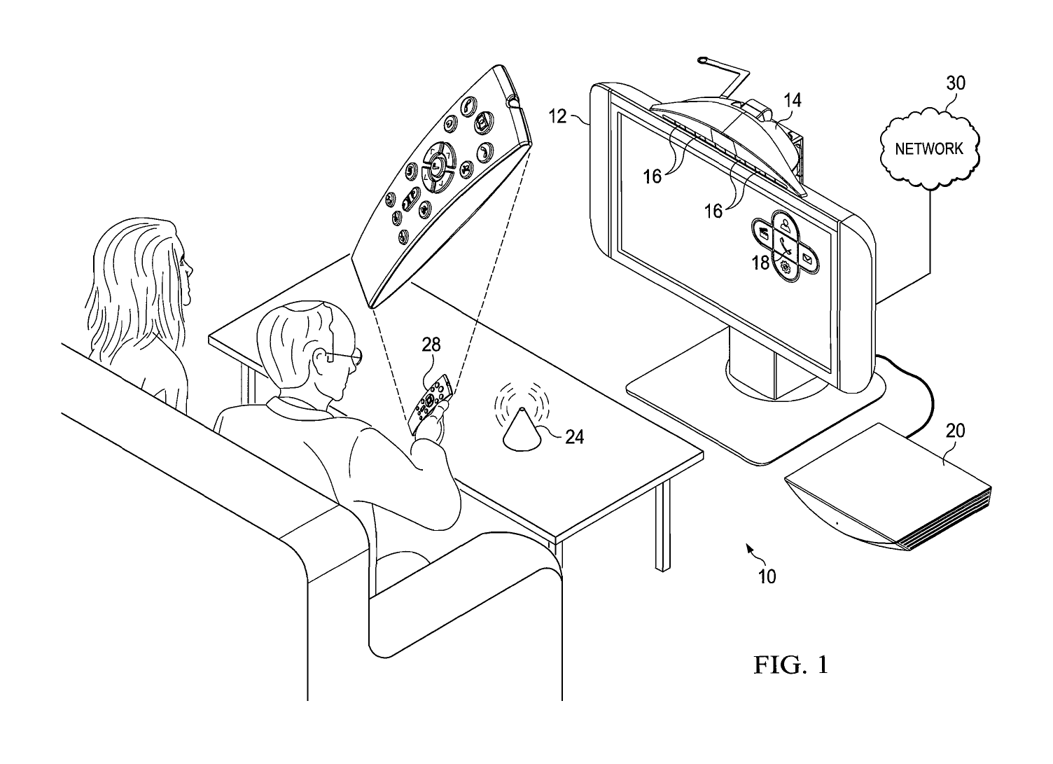

Turning to FIG. 1, FIG. 1 is a simplified block diagram of a system 10 for providing a video session in a network environment. In this particular example, system 10 may include a display 12, a camera element 14, a user interface (UI) 18, a console element 20, a handset 28, and a network 30. A series of speakers 16 are provisioned in conjunction with camera element 14 in order to transmit and receive audio data. In one particular example implementation, a wireless microphone 24 is provided in order to receive audio data in a surrounding environment (e.g., from one or more audience members). Note that this wireless microphone 24 is purely optional, as speakers 16 are capable of sufficiently capturing audio data in a surrounding environment during any number of videoconferencing applications (which are detailed below).

In general terms, system 10 can be configured to capture video image data and/or audio data in the context of videoconferencing. System 10 may include a configuration capable of transmission control protocol/internet protocol (TCP/IP) communications for the transmission and/or reception of packets in a network. System 10 may also operate in conjunction with a user datagram protocol/IP (UDP/IP) or any other suitable protocol, where appropriate and based on particular communication needs.

In certain implementations, handset 28 can be used as a remote control for system 10. For example, handset 28 can offer a wireless remote control that allows it to communicate with display 12, camera element 14, and/or console element 20 via a wireless network link (e.g., infrared, Bluetooth, any type of IEEE 802.11-based protocol, etc.). Handset 28 can further be provisioned as a wireless mobile phone (e.g., a speakerphone device) with various dial pads: some of which are shown by way of example in FIG. 1. In other implementations, handset 28 operates as a learning mechanism and/or a universal remote controller, which allows it to readily control display 12, camera element 14, console element 20, and/or any audiovisual (AV) receiver device (e.g., managing functions such as ON/OFF, volume, input select, etc. to enhance the overall video experience). In a particular set of examples, a specific button on handset 28 can launch UI 18 for navigating through any number of options provided in submenus of the UI software. Additionally, a dedicated button can be used to make/answer calls, end calls, turn on/off camera element 14, turn on/off the microphone on, turn on/off console element 20, etc. Furthermore, a set of playback controls can be provided on handset 28 in order to control the video data being rendered on display 12.

Note that handset 28 can be configured to launch, control, and/or manage UI 18. In one particular instance, UI 18 includes a clover design having four separate functions along its perimeter (i.e., up, down, left, right). The center of UI 18 can be used to initiate calls or to configure call options. The lower widget icon may be used to adjust settings, inclusive of controlling profile information, privacy settings, console settings, etc. The right-hand icon (when selected) can be used to view video messages sent to a particular user. The upper icon can be used to manage contacts (e.g., add, view, and connect to other individuals). The director's card (provided as the left icon) can be used to record and send video messages to other individuals. It is imperative to note that these menu choices can be changed considerably without departing from the scope of the present disclosure. Additionally, these icons may be customized, changed, or managed in any suitable fashion. Furthermore, the icons of UI 18 are not exhaustive, as any other suitable features may be provided in the context of UI 18. Along similar lines, the submenu navigation choices provided beneath each of these icons can include any suitable parameter applicable to videoconferencing, networking, user data management, profiles, etc.

In operation of an example implementation, system 10 can be used to conduct video calls (e.g., supporting both inbound and outbound directional call flows). For the inbound call scenario, on reception of an inbound call request, console element 20 is configured to contact the paired handset(s) 28 (e.g., waking it from sleep, where appropriate). Handset 28 can be configured to play a ringtone, turn on an LED indicator, and/or display UI 18 (e.g., including the incoming caller's contact information). If configured to do so, UI 18 can also be displayed over any passthrough video sources on console element 20. If the callee chooses to answer the call with one of the call control buttons, console element 20 offers its media capabilities to the caller's endpoint. In certain example implementations, by default, audio media can be offered at the start of the call. At any time during a voice call, both parties can agree to enter into a full video session (e.g., referred to as a “go big” protocol) at which point video media is negotiated. As a shortcut, the intention to “go big” can be pre-voted at the start of the call. At any time after video media is flowing, the call can also be de-escalated back to an audio-only call. In certain instances, there could be an option to automatically answer incoming calls as immediate full-video sessions.

In the case of an ad hoc outbound call, the user can select a callee from their contact list, select a callee via a speed dial setting, or alternatively the user can enter any type of identifier (e.g., a telephone number, a name, a videoconferencing (e.g., Telepresence, manufactured by Cisco, Inc. of San Jose, Calif.) number directly). If the callee answers, the call scenario proceeds, similar to that of an inbound call. In the case of a hold and resume scenario, an in-call UI 18 signal can be provided to put a call on hold, and subsequently the call can be resumed at a later time. Note that in other instances, system 10 can be used to execute scheduled calls, call transfer functions, multipoint calls, and/or various other conferencing capabilities.

In the case of the consumer user attempting a communication with a business entity, certain parameters may be changed based on interoperability issues. For example, secure business endpoints may be supported, where signaling and media would be secure (both audio and video). Appropriate messages can be displayed in UI 18 to inform the user of the reason for any security-forced call drops. Signaling can be considered secure by having both a business exchange and consumer networks physically co-located, or by using a secure tunnel (e.g., a site-to-site virtual private network (VPN) tunnel) between the two entities.

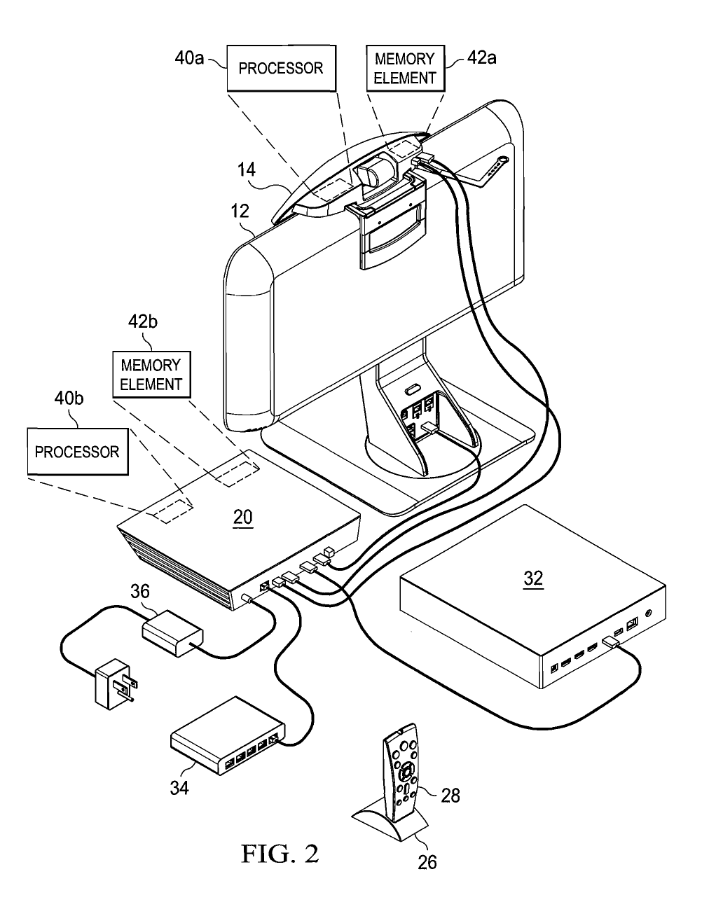

Before turning to additional flows associated with system 10, FIG. 2 is introduced in order to illustrate some of the potential arrangements and configurations for system 10. In the particular example implementation of FIG. 2, camera element 14 includes a processor 40a and a memory element 42a. Camera element 14 is coupled to console element 20, which similarly includes a processor 40b and a memory element 42b. A power cord 36 is provided between an outlet and console element 20. Any suitable connections (wired or wireless) can be used in order to connect any of the components of FIG. 2. In certain examples, the cables used may include Ethernet cables, High-Definition Multimedia Interface (HDMI) cables, universal serial bus (USB) cables, or any other suitable link configured for carrying data or energy between two devices.

In regards to a physical infrastructure, camera element 14 can be configured to fasten to any edge (e.g., a top edge) of display 12 (e.g., a flat-screen HD television). Camera element 14 can be included as part of an integrated component (i.e., a single component, a proprietary element, a set-top box, console element 20, etc.) that could include speakers 16 (e.g., an array microphone). Thus, all of these elements (camera element 14, speakers 16, console element 20) can be combined and/or be suitably consolidated into an integrated component that rests on (or that is fixed to, or that is positioned near) display 12. Alternatively, each of these elements are their own separate devices that can be coupled (or simply interact with each other), or be adequately positioned in any appropriate fashion.

Also provided in FIG. 2 are a router 34 and a set-top box 32: both of which may be coupled to console element 20. In a particular example, router 34 can be a home wireless router configured for providing a connection to network 30. Alternatively, router 34 can employ a simple Ethernet cable in order to provide network connectivity for data transmissions associated with system 10. Handset 28 can be recharged through a cradle dock 26 (as depicted in FIG. 2). [Handset 28 can be functional while docked.] Alternatively, handset 28 may be powered by batteries, solar charging, a cable, or by any power source, or any suitable combination of these mechanisms.

In one particular example, the call signaling of system 10 can be provided by a session initiation protocol (SIP). In addition, the media for the videoconferencing platform can be provided by Secure Real-time Transport Protocol (SRTP), or any other appropriate real-time protocol. SRTP addresses security for RTP and, further, can be configured to add confidentiality, message authentication, and replay protection to that protocol. SRTP is preferred for protecting voice over IP (VoIP) traffic because it can be used in conjunction with header compression and, further, it generally has no effect on IP quality of service (QoS). For network address translation (NAT)/firewall (FW) traversal, any suitable mechanism can be employed by system 10. In one particular example, these functions can be provided by a split-tunneled VPN with session traversal utilities for NAT (STUN) and Interactive Connectivity Establishment (ICE).

Signaling can propagate to a call agent via the VPN. Additionally, media can be sent directly from the endpoint to another endpoint (i.e., from one videoconferencing platform to another). Note that as used herein, the term ‘media’ is inclusive of audio data (which may include voice data) and video data (which may include any type of image data). The video data can include any suitable images (such as that which is captured by camera element 14, by a counterparty's camera element, by a Webcam, by a smartphone, by an iPad, etc.). The term ‘smartphone’ as used herein includes any type of mobile device capable of operating in conjunction with a video service. This would naturally include items such as the Google Droid, the iPhone, an iPad, etc. In addition, the term ‘signaling data’ is inclusive of any appropriate control information that can be sent toward a network. This may be inclusive of traffic used to establish a video session initially, along with any type of negotiations (e.g., for bit rates, for bandwidth, etc.) that may be appropriate for the particular videoconference. This may further be inclusive of items such as administrative traffic, account traffic (for user account management, contact lists [which include buddy lists, as detailed below], etc.), and/or other types of traffic, which are not provided as part of the media data.

In order to handle symmetric NAT, Traversal Using Relay NAT (TURN) can be used by system 10 in particular embodiments. User names for the videoconferencing platform can be provided by E.164 numbers in a particular example. Alternatively, the user naming can be a simple user ID (e.g., assigned by the service provider, selected by the user, etc.), a full name of the user (or a group name), an avatar, or any other symbol, number, or letter combination that can be used to distinguish one user from another. Note that a single name can also be associated with a group (e.g., a family, a business unit, etc.). The security for communications of system 10 can be addressed a number of ways. In one implementation, the video services (i.e., cloud services) can be protected by any suitable security protocol (e.g., security software, adaptive security appliances (ASA), etc.). Additionally, intrusion protection systems, firewalls, anti-denial of service mechanisms can be provided for the architecture (both out in the network, and/or locally within a residential environment).

Turning to details associated with the infrastructure of system 10, in one particular example, camera element 14 is a video camera configured to capture, record, maintain, cache, receive, and/or transmit image data. This could include transmitting packets over network 30 to a suitable next destination. The captured/recorded image data could be stored in camera element 14 itself, or be provided in some suitable storage area (e.g., a database, a server, console element 20, etc.). In one particular instance, camera element 14 can be its own separate network device and have a separate IP address. Camera element 14 could include a wireless camera, a high-definition camera, or any other suitable camera device configured to capture image data.

Camera element 14 may interact with (or be inclusive of) devices used to initiate a communication for a video session, such as a switch, console element 20, a proprietary endpoint, a microphone, a dial pad, a bridge, a telephone, a computer, or any other device, component, element, or object capable of initiating video, voice, audio, media, or data exchanges within system 10. Camera element 14 can also be configured to include a receiving module, a transmitting module, a processor, a memory, a network interface, a call initiation and acceptance facility such as a dial pad, one or more displays, etc. Any one or more of these items may be consolidated, combined, eliminated entirely, or varied considerably and those modifications may be made based on particular communication needs.

Camera element 14 can include a high-performance lens and an optical zoom, where camera element 14 is capable of performing panning and tilting operations. The video and the audio streams can be sent from camera element 14 to console element 20, where they are mixed into the HDMI stream. In certain implementations, camera element 14 can be provisioned as a light sensor such that the architecture can detect whether the shutter of the camera is open or closed (or whether the shutter is partially open.) An application program interface (API) can be used to control the operations of camera element 14.

Display 12 offers a screen at which video data can be rendered for the end user. Note that as used herein in this Specification, the term ‘display’ is meant to connote any element that is capable of delivering image data (inclusive of video information), text, sound, audiovisual data, etc. to an end user. This would necessarily be inclusive of any panel, plasma element, television (which may be high-definition), monitor, computer interface, screen, Telepresence devices (inclusive of Telepresence boards, panels, screens, surfaces, etc.) or any other suitable element that is capable of delivering/rendering/projecting such information.

Network 30 represents a series of points or nodes of interconnected communication paths for receiving and transmitting packets of information that propagate through system 10. Network 30 offers a communicative interface between any of the components of FIGS. 1-2 and remote sites, and may be any local area network (LAN), wireless local area network (WLAN), metropolitan area network (MAN), wide area network (WAN), VPN, Intranet, Extranet, or any other appropriate architecture or system that facilitates communications in a network environment.

Console element 20 is configured to receive information from camera element 14 (e.g., via some connection that may attach to an integrated device (e.g., a set-top box, a proprietary box, etc.) that sits atop (or near) display 12 and that includes (or is part of) camera element 14). Console element 20 may also be configured to control compression activities, or additional processing associated with data received from camera element 14. Alternatively, the actual integrated device can perform this additional processing before image data is sent to its next intended destination. Console element 20 can also be configured to store, aggregate, process, export, or otherwise maintain image data and logs in any appropriate format, where these activities can involve processor 40b and memory element 42b. Console element 20 is a video element that facilitates data flows between endpoints and a given network. As used herein in this Specification, the term ‘video element’ is meant to encompass servers, proprietary boxes, network appliances, set-top boxes, or other suitable device, component, element, or object operable to exchange video information with camera element 14.

Console element 20 may interface with camera element 14 through a wireless connection, or via one or more cables or wires that allow for the propagation of signals between these elements. These devices can also receive signals from an intermediary device, a remote control, handset 28, etc. and the signals may leverage infrared, Bluetooth, WiFi, electromagnetic waves generally, or any other suitable transmission protocol for communicating data (e.g., potentially over a network) from one element to another. Virtually any control path can be leveraged in order to deliver information between console element 20 and camera element 14. Transmissions between these two devices can be bidirectional in certain embodiments such that the devices can interact with each other. This would allow the devices to acknowledge transmissions from each other and offer feedback where appropriate. Any of these devices can be consolidated with each other, or operate independently based on particular configuration needs. In one particular instance, camera element 14 is intelligently powered using a USB cable. In a more specific example, video data is transmitted over an HDMI link, and control data is communicated over a USB link.

In certain examples, console element 20 can have an independent light sensor provisioned within it to measure the lighting in a given room. Subsequently, the architecture can adjust camera exposure, shuttering, lens adjustments, etc. based on the light that is detected in the room. Camera element 14 is also attempting to provide this function; however, having a separate light sensor offers a more deterministic way of adjusting these parameters based on the light that is sensed in the room. An algorithm (e.g., within camera element 14 and/or console element 20) can be executed to make camera adjustments based on light detection. In an IDLE mode, the lens of camera element 14 can close automatically. The lens of camera element 14 can open for an incoming call, and can close when the call is completed (or these operations may be controlled by handset 28). The architecture can also account for challenging lighting environments for camera element 14. For example, in the case of bright sunlight behind an individual, system 10 can optimize the exposure of the individual's face.

In regards to audio data (inclusive of voice data), in one particular example, speakers 16 are provisioned as a microphone array, which can be suitably calibrated. Note that in certain consumer applications, the consumer's home system is the variant, which is in contrast to most enterprise systems that have fixed (predictable) office structures. Camera element 14 can include an array of eight microphones in a particular example, but alternatively any number of microphones can be provisioned to suitably capture audio data. The microphones can be spaced linearly, or logarithmically in order to achieve a desired audio capture function. A MicroElectrical-Mechanical System (MEMS) technology can be employed for each microphone in certain implementations. The MEMS microphones represent variations of the condenser microphone design, having a built in analog-to-digital converter (ADC) circuits.

The audio mechanisms of system 10 can be configured to add a delay to the system in order to ensure that the acoustics function properly. In essence, the videoconferencing architecture does not inherently know the appropriate delay because of the unique domain of the consumer. For example, there could be a home theater system being used for acoustic purposes. Hence, system 10 can determine the proper delay, which would be unique to that particular environment. In one particular instance, the delay can be measured, where the echoing effects from the existing speakers are suitably canceled. An embedded watermarking signature can also be provided in each of the speakers, where the signature can be detected in order to determine an appropriate delay. Note that there is also some additional delay added by display 12 itself because the clocking mechanism is generally not deterministic. The architecture can dynamically update the delay to account for this issue. Many of these functions can be accomplished by console element 20 and/or camera element 14: both of which can be intelligently configured for performing these function adjustments.

The architecture can also send out a signal (e.g., white noise) as a test for measuring delay. In certain instances, this function is done automatically without having to prompt the user. The architecture can also employ wireless microphone 24, which can use a dedicated link in certain implementations. Wireless microphone 24 can be paired (akin to Bluetooth pairing) such that privacy issues can be suitably addressed. Wireless microphone 24 can be taken anywhere (i.e., in the room, in the house, etc.) and still provide appropriate audio functions, where multiplexing would occur at console element 20 for this particular application. Similarly, there could be an incarnation of the same for a given speaker (or the speaker/microphone can be provided together as mobile units, which are portable). The speaker could be similarly used anywhere in the room, in the house, etc. It should be noted that this is not only a convenience issue, but also a performance issue in suitably capturing/delivering audio signals having the proper strength and quality.

In terms of call answering and video messaging, handset 28 allows an individual to have the option of taking a voice call instead of answering a videoconferencing call. This is because handset 28 can have the intelligence to operate purely as a mobile phone. For this reason, handset 28 can readily be substituted/replaced by various types of smartphones, which could have an application provisioned thereon for controlling the videoconferencing activities. Handset 28 also affords the ability to be notified (through the handset itself) of an incoming videoconferencing call, with the option of rendering that call on display 12. A simple visual alert (e.g., an LED, a vibration, etc.) can be used to indicate a video message is waiting to be heard/watched.

The video messaging can include snapshots of video frames that would be indicative of the actual message images. In the user's video Inbox, the current videomail can include images of the actual messages being stored for future playback. For example, if the message were from the user's mother, the videomail would include a series of snapshots of the mother speaking during that videomail. In one particular example, the actual videomail is sampled at certain time intervals (e.g., every 10 seconds) in order to generate these images, which serve as a preview of the videomail message. Alternatively, the snapshots can be limited in number. In other instances, the snapshots are arbitrarily chosen, or selected at the beginning, the middle, and the end of the video message. In other implementations, the snapshots are taken as a percentage of the entire video message (e.g., at the 20% mark, at the 40% mark, and at the 100% mark). In other examples, the videomail in the Inbox is previewed by just showing the image associated with that particular user ID that authored the video message.

In operation of an example involving a user watching a normal television program on display 12, an incoming call can be received by the videoconferencing platform. The notification can arrive even if the television is off (e.g., through speakers of system 10). If an individual chooses to answer the call, then the videoconferencing platform takes over the television. In one example involving a digital video recorder (DVR), the programming can be paused. In other examples, the user can keep the call minimized so (for example) a user could speak with a friend while watching a football game. Console element 20 can be configured to record a message, and then send that message to any suitable next destination. For example, the user can send a link to someone for a particular message. The user can also use Flip Share or YouTube technology to upload/send a message to any appropriate destination. In a general sense, the messages can be resident in a network cloud such that they could still be accessed (e.g., over a wireless link) even if the power were down at the residence, or if the user were not at the residence.

The user can also switch from a video call to handset 28, and from handset 28 back to a video call. For example, the user can initiate a call on a smartphone and subsequently transition it to the videoconferencing display 12. The user can also do the reverse, where the user starts at the videoconferencing platform and switches to a smartphone. Note that wireless microphone 24 can operate in a certain, preferred range (e.g., 12 to 15 feet), where if the individual moves further away from that range, users could elect to transition to handset 28 (in a more conventional telephony manner). Consider the case where the room becomes noisy due to family members, and the user on the videoconferencing call elects to simply switch over to a smartphone, to a given landline, etc.

Motion detection can also be used in order to initiate, or to answer video calls. For example, in the case where a remote control is difficult to find in a living room, a simple hand-waving gesture could be used to answer an incoming video call. Additionally, the system (e.g., camera element 14 cooperating with console element 20) can generally detect particular body parts in order to execute this protocol. For example, the architecture can distinguish between a dog running past display 12, versus handwaving being used to answer an incoming call. Along similar lines, the user can use different gestures to perform different call functions (e.g., clasping his hands to put a call on hold, clapping his hands to end the call, pointing in order to add a person to a contact list, etc.).

Note that Wi-Fi is fully supported by system 10. In most videoconferencing scenarios, there can be massive amounts of data (much of which is time critical) propagating into (or out of) the architecture. Video packets (i.e., low-latency data) propagating over a Wi-Fi connection can be properly accommodated by system 10. In one particular example, nonmoving (static) background images can be segmented out of the video image, which is being rendered by display 12. The architecture (e.g., through console element 20) can then lower the bit rate significantly on those images. Allocations can then be made for other images that are moving (i.e., changing in some way). In certain example implementations, face-detection algorithms can also be employed, where the video is optimized based on those algorithm results.

Certain phone features allow for handset 28 to offer speed dialing, and a mechanism for saving contacts into a contact list. Calls can be made to users on the speed dial list or the contact list with a single button push on handset 28. Additionally, calls can be initiated using either the UI of handset 28, or the on-screen UI 18. Furthermore, calls can be initiated from a web portal, where the caller can confirm call initiation at the endpoint by pressing voice-only, or a video call button on handset 28. Also, calls can be initiated from other web pages via a call widget (e.g., calling a person by clicking on his Facebook object). In addition, the caller can look up a recipient in an online directory (e.g., a directory of all Telepresence users stored in a database), place a call to that recipient, and save the recipient's contact information into the contact list. In terms of receiving videoconferencing calls, incoming calls can be accepted with a single button push on handset 28. Call recipients have the opportunity to accept or reject a call. Rejected calls can be routed to videomail (if permitted by the recipient's safety settings).

In regards to call quality, if the available bandwidth decreases during a call, the video resolution is scaled down, as appropriate. If the available bandwidth increases during a call, the video resolution can be scaled up. An on-screen icon can be provided on display 12 to inform the user of the quality of his videoconferencing experience. The purpose of this information can be to inform the user of a poor experience, potentially being caused by network conditions, and that the user can improve his experience by upgrading his broadband service. When communicating with a Webcam, the picture on display 12 can be windowed inside a black frame: regardless of the actual quality of the Webcam video.

In regards to videomail, when a call cannot be answered in real time, it is not lost, but rather, forwarded automatically to videomail. Videomail can be accessed from the videoconferencing system, a web portal, a smartphone, laptop, or any other suitable endpoint device to be used by a user. Note that the user is afforded the ability to set a designated interval for when an incoming counterparty would be relegated to the user's videomail Inbox. The term ‘designated interval’ is inclusive of a number of rings, a certain time period (e.g., in seconds), or a zero interval, in which case the counterparty's video call request would be immediately routed to the user's videomail. In certain embodiments, the ‘designated interval’ has a default configured by an administrator.

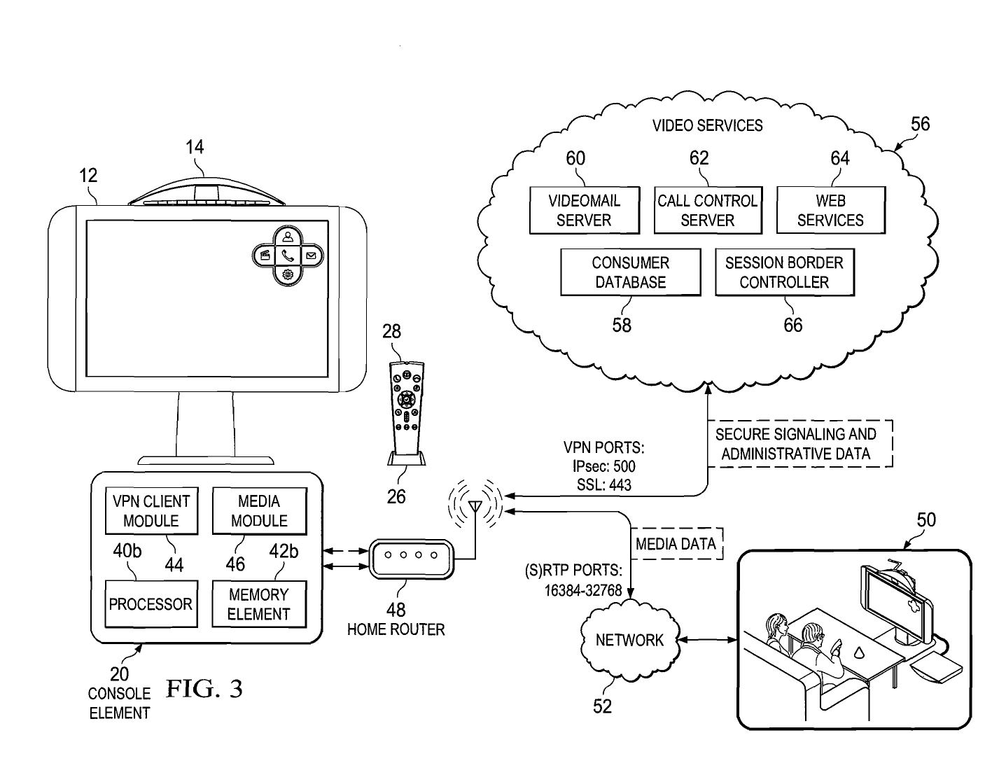

Videomail can be stored in the network (e.g., in the cloud) in particular implementations of system 10. Alternatively, the videomail can be stored locally at the consumer's residence (e.g., at a laptop, a personal computer, an external hard drive, a server, or in any other appropriate data storage device). Videomail can be played with the following minimum set of playback controls: Play, Pause, Stop, Fast or Skip Forward, Fast or Skip Reverse, Go Back to Start. In a particular implementation, videomail is only viewed by the intended recipient. Notifications of new videomail can be sent to other devices by short message service (SMS) text message (e.g., to a mobile device) or by email. An immediate notification can also be shown on handset 28. For video recordings, videos can be recorded and stored in the network for future viewing and distribution (e.g., as part of video services, which are detailed below with reference FIG. 3). Calls can similarly be recorded in real time and stored in the network for future viewing and distribution. When sharing recorded videos with videoconferencing users, the architecture can specify exactly which videoconferencing users have access to the video data. When the share list contains one or more email addresses, access control is not enabled in particular implementations (e.g., any individual who has the URL could access the video).

In terms of media sharing, system 10 can provide a simple mechanism for sharing digital photos and videos with removable flash media, flash and hard-drive high definition digital camcorders, digital still cameras, and other portable storage devices. This can be fostered by supporting an external USB connection for these devices to the USB port, which can be provisioned at console element 20, display 12, camera element 14, a proprietary device, or at any other suitable location.

The media sharing application (e.g., resident in console element 20) supports playback of compressed AV file media that is stored on the USB device. Furthermore, this media sharing can be supported via an external HDMI connection for these devices to the HDMI port. System 10 can also provide a mechanism for sharing digital photos and videos that are on a computer, on a Network Attached Storage (NAS) device, on the local network, etc. The mechanism can be universal plug and play (UPnP)/digital living network alliance (DLNA) renderer compliant. The media sharing application can also provide a mechanism for sharing digital photos and videos that are on either a photo or video sharing site (e.g., Flickr, YouTube, etc.), as discussed herein.

System 10 can also provide a mechanism for viewing broadcast HDTV programs (e.g., watching the Superbowl) with the HDTV set-top box HDMI AV feed displayed in picture-in-picture (PIP) with the call video. Continuing with this example, the Super Bowl broadcast feed can be from a local set-top box 32 and not be shared. Only the call video and voice would be shared in this example. The audio portion of the call can be redirected to handset 28 (e.g., speakerphone by default). The audio from the local TV can be passed through to HDMI and optical links (e.g., TOSlink outputs).

In an example scenario, initially the game video can fill the main screen and the call video could be in the smaller PIP. The audio for the game can pass through the box to the television, or to AV receiver surround-sound system. The audio for the video call would be supported by handset 28. In a different scenario, while watching the game, where one caller prefers to switch the main screen from the game to the video call (e.g., during halftime), then the following activities would occur. [Note that this is consistent with the other PIP experiences.] The call video can fill the main screen, where the game fills the smaller PIP window. The audio for the video call can move to the TV or to the AV receiver surround-sound system, and the game audio can switch to handset 28. Note that none of these activities requires the user to be “off camera” to control the experience: meaning, the user would not have to leave his couch in order to control/coordinate all of these activities.

In one particular example, console element 20 and camera element 14 can support any suitable frame rate (e.g., a 50-60 frames/second (fps) rate) for HD video for local, uncompressed inputs and outputs. Additionally, the video (e.g., the HDMI 1.3 video) can be provided as a digital signal input/output for local, uncompressed inputs and outputs. There is a passthrough for high-bandwidth Digital Content Protection (HDCP) data for local, uncompressed inputs and outputs from HDMI.

In regards to audio support, HDMI audio can be provided as a digital signal input/output. There can also be a stereo analog line-level output to support legacy devices in the environment. This is in addition to a digital audio output, which may be in the form of an optical link output such as a TOSlink output. For the audiovisual switching activities, audio and video can be patched from inputs, videoconferencing video, or other generated sources, to a local full-screen output. The architecture can offer a protocol for automatically turning on and selecting the correct source of the HDTV (along with any external audio system, when the audiovisual configuration allows for this while answering a call). This feature (and the other features of handset 28) can be implemented via infrared, Bluetooth, any form of the IEEE 802.11 protocol, HDMI-Consumer Electronics Control (CEC), etc.

In regards to camera element 14, the architecture can provide a full-motion video (e.g., at 30 fps). Participants outside of the range may be brought into focus via autofocus. Camera element 14 can provide identification information to console element 20, a set-top satellite, and/or any other suitable device regarding its capabilities. Camera element 14 can be provisioned with any suitable pixel resolution (e.g., 1280×720 pixel (720p) resolution, 1920×1080 pixel (1080p) resolution, etc.). If depth of focus is greater than or equal to two meters, then manual focus can be suggested for setup activities, and the autofocus feature/option would be desirable for the user. In operation, the user can manually focus camera element 14 on his sofa (or to any other target area) during setup. If successful, this issue would not have to be revisited. If depth of focus is less than or equal to one meter (which is commonly the case) then autofocus can be implemented. A digital people-action finder may also be provisioned for system 10 using camera element 14. Both pan and tilt features are available manually at setup, and during a video call. Similarly, zoom is available manually at set-up time, and during a video call.

Handset 28 may be equipped with any suitable microphone. In one particular implementation, the microphone is a mono-channel mouthpiece microphone optimized for capturing high quality audio in a voice range. The microphone may be placed to optimize audio capture with standard ear-mouth distance. Handset 28 can have a 3.5 mm jack for a headphone with microphone. Note that system 10 can support Home Network Administration Protocol (HNAP) and, further, be compatible with Network Magic, Linksys Easy-Link Advisor, or any other suitable home network management tool.

In one example, handset 28 has an infrared transmitter for controlling standard home theatre components. The minimum controls for handset 28 in this example can be power-on, input select, volume up/down, and audio output mute of the TV and AV receiver. Console element 20 (along with camera element 14) can have an infrared receiver to facilitate pairing of the videoconferencing system with other remote controls, which can allow other remotes to control the videoconferencing system. Suitable pairing can occur either by entering infrared codes into handset 28, or by pointing a remote from the target system at an infrared receiver of the videoconferencing system (e.g., similar to how universal remotes learn and are paired).

For call management, system 10 can allow a user to initiate, accept, and disconnect calls to and from voice-only telephones (e.g., using handset 28 in a voice-only mode). Call forwarding can also be provided such that video calls are forwarded between console elements 20 at each endpoint of the video session. Additionally, announcements can be provided such that a default announcement video can be played to callers who are leaving a videomail. A self-view is available at any time, and the self-view can be triggered through a user demand by the user pressing a button on handset 28. The self-view can be supported with a mirror mode that shows the reverse image of the camera, as if the user was looking in a mirror. This can occur at any time, including while idle, while on a videoconferencing call, while on an audio-only call, etc.

FIG. 3 is a simplified block diagram illustrating one potential operation associated with system 10. In this particular implementation, console element 20 is provisioned with a VPN client module 44, and a media module 46. Console element 20 is coupled to a home router 48, which can provide connectivity to another videoconferencing endpoint 50 via a network 52. Home router 48 can also provide connectivity to a network that includes a number of video services 56. In this example, video services 56 include a consumer database 58, a videomail server 60 a call control server 62, a web services 64, and a session border controller 66.

Any number of traffic management features can be supported by system 10. In a simple example, system 10 can allow a point-to-point connection to be made between two home video conferencing systems. A connection can also be made between a home video conferencing system and an enterprise videoconferencing system. The packets associated with the call may be routed through a home router, which can direct the packets to an exchange or a gateway in the network. The consumer endpoint does not need to support the second data channel; any shared content can be merged into the main data stream. A multipoint connection can be made between a combination of three or more home and enterprise videoconferencing systems.

In operation, the VPN is leveraged in order to transmit administrative and signaling traffic to the network. Additionally, the media data [e.g., voice and video] can be exchanged outside of that link (e.g., it can be provisioned to flow over a high bandwidth point-to-point link). This linking can be configured to protect administrative and signaling traffic (which may be inclusive of downloads), while simultaneously conducting high-speed data communications over the point-to-point pathway.

In the particular example of FIG. 3, secure signaling and administrative data is depicted as propagating between home router 48 and video services 56. A number of VPN ports are also illustrated in FIG. 3. The ports can be associated with any appropriate security protocol (e.g., associated with IPsec, secure socket layer (SSL), etc.). Additionally, media data can propagate between network 52 and home router 48, where RTP ports are being provisioned for this particular exchange involving a counterparty endpoint 50. Semantically, multiple pathways can be used to carry the traffic associated with system 10. In contrast to other applications that bundle their traffic (i.e., provide a single hole into the firewall), certain implementations of system 10 can employ two different pathways in the firewall: two pathways for carrying two different types of data.

The objects within video services 56 are network elements that route or that switch (or that cooperate with each other in order to route or switch) traffic and/or packets in a network environment. As used herein in this Specification, the term ‘network element’ is meant to encompass servers, switches, routers, gateways, bridges, loadbalancers, firewalls, inline service nodes, proxies, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information.

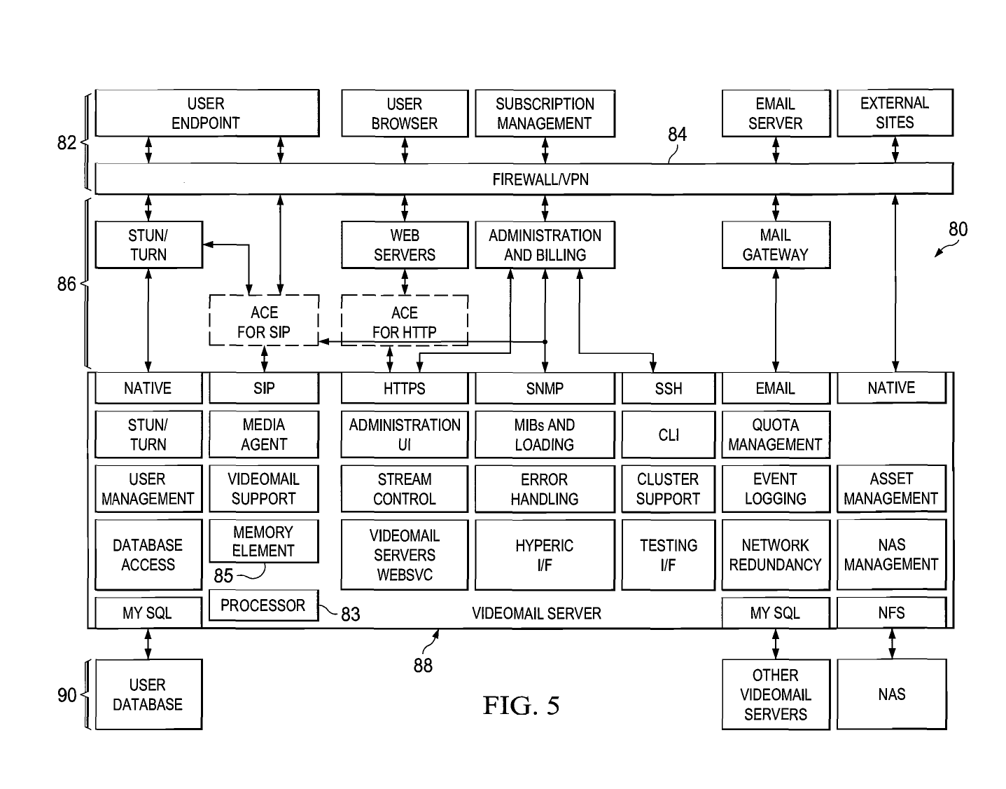

Note that videomail server 60 may share (or coordinate) certain processing operations between any of the elements of video services 56. Using a similar rationale, their respective memory elements may store, maintain, and/or update data in any number of possible manners. In one example implementation, videomail server 60 includes software (e.g., as part of the modules of FIG. 5) to achieve the videomail applications involving the user, as described herein. In other embodiments, these features may be provided externally to any of the aforementioned elements, or included in some other network element to achieve this intended functionality. Alternatively, several elements may include software (or reciprocating software) that can coordinate in order to achieve the operations, as outlined herein. In still other embodiments, any of the devices of the FIGURES may include any suitable algorithms, hardware, software, components, modules, interfaces, or objects that facilitate these switching operations.

In certain instances, videomail 60 can be provisioned in a different location, or some other functionalities can be provided directly within the videoconferencing platform (e.g., within console element 20, camera element 14, display 12, etc.). This could be the case in scenarios in which console element 20 has been provisioned with increased intelligence to perform similar tasks, or to manage certain repositories of data for the benefit of the individual user.

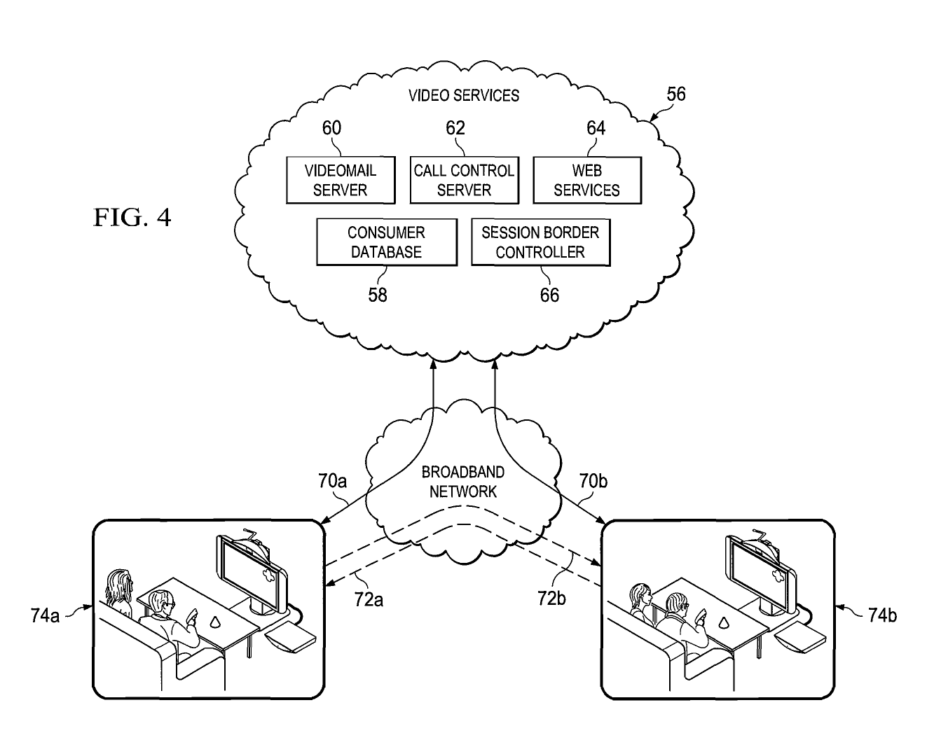

FIG. 4 is a simplified block diagram illustrating additional details associated with call signaling and call media. In this particular instance, the call media links are provided in broken lines, whereas the call signaling links are provided as straight-lines. More specifically, call signaling propagates from a set of endpoints 74a-b over a broadband network, where these links have a suitable connection at video services 56. These links are labeled 70a-b in the example of FIG. 4. Video services 56 include many of the services identified previously with respect to FIG. 3. Call media between endpoints 74a-b propagate over the broadband network, where these links are identified as 72a-b. Endpoints 74a-b are simply videoconferencing entities that are leveraging the equipment of system 10.

FIG. 5 is a simplified block diagram of an example implementation 80 of a video messaging aspect of system 10. FIG. 5 includes multiple levels 82, 86, and 90 of the video messaging architecture. Additionally, FIG. 5 includes a firewall/VPN 84 and a videomail server 88, which includes a processor 83 and a memory element 85. The first level of this particular architecture can include a user endpoint, a user browser, a subscription management element, an e-mail server, and a block associated with external sites. The elements of level 82 may traverse firewall/VPN 84 in order to access level 86. That particular level may include a STUN/TURN element, multiple Web servers, an administrative and billing element, and a mail gateway. The STUN/TURN element may interface with an application control engine (ACE) for SIP, while Web servers may interact with an ACE for HTTP.

A user database may be provisioned at level 90, which can interface with videomail server 88. Additionally, other videomail servers and a NAS may interface with videomail server 88. Videomail server 88 may include any number of components for managing, coordinating, processing, or otherwise handling videomail messages. In this particular example, videomail server 88 includes components such as a SIP element, an HTTPS element, a Simple Network Management Protocol (SNMP) element, a secure shell (SSH) element, an e-mail element, along with native components.

Also provided in videomail server 88 are items such as STUN/TURN, a media agent, an administrative UI, a management information bases (MIBs) and loading element, a command line interface (CLI), quota management, user management, videomail support, stream control, error handling, cluster support, event logging, network redundancy, NAS management, testing, a Hyperic element, database access, a MySQL element, etc. Note that any of these modules may be representative of software, hardware, algorithms, or any suitable hybrid of these elements. Additionally, any of these components can be replaced, added to, augmented, modified, removed, or changed considerably without departing from the teachings of the present disclosure.

Turning to operational aspects associated with the example implementation illustrated in FIG. 5, one activity to be executed by the architecture is associated with the initial system startup. In one particular example scenario, this may begin by configuring a NAS redundant array of independent disks (RAID), where the NAS would subsequently be started. Afterward, a single user database server may be configured. Databases may be then initialized with a preliminary schema with no entries. Once this has been completed, any number of components may be started such as the STUN/TURN server, the web servers, the Hyperic system, the administrative console, the firewall, etc. The exact ordering of this initialization is not important. Videomail server 88 may be configured with the appropriate NAS, user database locations, etc. Afterward, a new user account can be created for one or more new users.

Logistically, to support error notifications prior to the availability of the Hyperic system, an outbound email server can be supported. Hyperic is an open source application that provides monitoring and management for web infrastructure. Email is already supported via SMTP. In the event that the videoconferencing architecture does not support SMTP, videomail server 88 can be configured to provide an appropriate email gateway protocol. Additionally, a software STUN/TURN agent can be integrated into the codebase of videomail server 88 to provide the ability to determine how best to communicate with the user endpoint (e.g., based on the STUN/TURN agent's findings). The media agent can be responsible for session control of the record and playback facility of videomail server 88.

The administrative user interface can be updated to support the functionality required for videoconferencing services. The SNMP MIBs can be updated to reflect the new consumer functionality. The SNMP feedback to the ACE blades can provide the ACE with an accurate metric to determine loading. The load of videomail server 88 can be calculated based on the number of supported simultaneous sessions, and be reflected as such to the ACE blades. The command line interface can be updated to reflect any new consumer functionality. The command line interface can contain commands to lookup accounts and user information, to view and control active sessions, to initiate new sessions, and to perform other tests and administration-related functions, as appropriate.

To achieve a greater understanding for the end user, quotas can be specified in units of minutes in a particular implementation. Other implementations may be based on volume of data, types of data, or any suitable hybrid of these elements. Quotas can be enforced by checking the quota availability when a caller is leaving a message for a user, when a user wants to record a personal message, or when a user wants to share messages with another user. The user management function can be accessed via an external API of videomail server 88. Its function can be to manipulate accounts and account settings, and user settings within the user database. When provisioning a new account, a new entry can be created in the user database, along with the initial user configuration, including information such as the quota and maximum call duration.

For videomail server 88, the recording/replaying functionality can be extended to provide a mixed mode replaying/recording for an incoming call that has been redirected to videomail server 88. Features of the SIP call state machine and the media signaling agent on both videomail server 88 and the videoconferencing endpoint can achieve this functionality. to support recording a greeting for playback when a user is not available (e.g., “HI, I'm not home right now, please leave a video message”), the external API can be extended to provide a mechanism to record personal greetings to be played back when someone leaves a videomail. The user management component can provide the mailbox functionality to store a list of videomails. Videomail messages contain the typical envelope information that includes the sender's ID, date/time sent, text message/metadata, and/or a pointer to the video asset.

The consumer endpoint can feature an indicator that is intended to indicate that a videomail message is waiting. Videomail server 88 can provide the mechanism to push the message waiting notification. In order to prevent a flood of message alerts, updates to the user endpoint message waiting indicator can be rate limited. ‘Message Waiting’ updates can be delivered per the RFC 3842 specification, or via any other appropriate mechanism. A SIP NOTIFY message can be sent to the endpoint to indicate messages are available, or not available. The endpoint may also probe for new messages at any time, including at boot-up or at recovery from a loss of internet connectivity.

The endpoint's message waiting indicator is toggled on when the following events have occurred: 1) a videomail has been left for a user; 2) a videomail previously marked as read is now marked as unviewed; 3) a personal message has been shared; and 4) a personal message has been marked as unviewed. Additionally, the message waiting indicator is toggled off when the following events have occurred: 1) a videomail is viewed and no other recordings are marked as unviewed; 2) a videomail is marked as viewed and no other recordings are marked as unviewed; 3) a personal message is viewed and no other recordings are marked as unviewed; and 4) a personal message is marked as viewed and no other recordings are marked as unviewed.

Stream control provides the hooks to allow various administrative interfaces the ability to display and control playback/recording sessions. Videomail server 88 provides a wealth of error and status notification methods, including email, SNMP traps, syslog and secure syslog logging, and administrative web interface alerts. Videomail server 88 notifications can also provide SIP and Hyperic alerts. Although the email functionality can provide the ability to send notifications to the end user, this function can be configured by the user based on preferences. The call control can determine the exact mechanism of user contact based on system and user settings (e.g., sending an endpoint pop-up, sending emails to the user's specified notification email list, etc.).

The Asset Index provides a simple lookup table interface, translating an asset identifier into a fully-qualified NAS location. When there is a 1-to-1 mapping between an asset identifier and an asset, this translation is straightforward. However, when replicants of the video message exist, a policy decision can be made that selects the most appropriate asset to present based on a user request. This decision can be based on the reason the asset was replicated in the first place (e.g., loadbalancing, geographical locality, and/or redundancy).

The Asset Index can be hosted on the user database servers. The user database server can have a full (replicated) copy of the Asset Index. Changes to the Asset Index can require replicated updates to each user database server. For the purpose of video distribution and content indexing, a distributed file sharing (e.g., distributed hash tables (DHT)) can be provided. This differs from conventional file sharing implementations (such as Azureus or Bit Torrent) in that it is optimized for use in a service provider architecture. The distributed file sharing also provides a mechanism for automated and supervised replication of assets, and for determining the most available (or the closest copy) of an asset. Additionally, the distributed filesharing provides the ability to select the closest/cheapest/most available NAS for recording or playback.

The database access component can be responsible for providing read/write access to the user database. The user database does not have to be provisioned on videomail server 88; rather it can be hosted on several external servers. The user database servers can maintain some measure of redundancy, where each account is replicated to at least two geographically-dispersed servers, and a transactional account-locking mechanism is used to prevent multiple writers and potential database corruption. Account data can be across the user database servers to provide horizontal scalability. The user database can allow for schema updates on a per-user-account basis. In this way, database updates can be accomplished in a real-time manner without locking out the entire database.

Upon creation, each new account can be assigned a numeric account number that uniquely identifies the account. Each videoconferencing endpoint has an entry in the database that contains information such as whether it is active, to which account it may be linked, whether it is online, its current IP address/port, etc. Upon creation, each videoconferencing user can be granted an identifier string (e.g., a consecutive numeric user ID number) that uniquely identifies the user. This identifier string may be based on the account number to provide easy mapping from user number to the owner account number. A user represents an individual person who is reachable via the consumer videoconferencing system. Each user also has one (or perhaps several) associated active identifier strings, although this may be changed over time by an administrator, or by a user. Each allocated alphanumeric user ID can be unique over all time in particular embodiments. Note that as used herein in this Specification, the term ‘identifier string’ is meant to include alphanumeric combinations, user IDs, phone numbers, symbols, icons, objects, characters, avatars, tags, images, or any other appropriate identifier or any suitable combination of these elements. User entries can contain data such as their own contact email address(es), phone number(s) for voice/SMS access, sharing lists, and a list of owned video assets (Inbox, saved, created/ingested).

In order to adequately address a large service offering, each videomail server 88 in the service cluster can be able to access all video assets. This can permit loadbalancing over multiple videomail (VM) servers, while still providing for massive, distributed storage of videomail content. The NAS also provides direct administrative access via a given network (e.g., a LAN). The NAS can support FCP, iSCSI, network file system (NFS), CIFS, etc. for file system access. Communications involving the consumer videoconferencing endpoint and a business videoconferencing endpoint can entail certain trade-offs such that the lowest-common-denominator can be accommodated. This can involve trade-offs involving the codec parameters (bitrates and resolutions), MUX protocol options, appropriate encoding, etc. Note that any suitable negotiation or arbitration between slightly different videoconferencing endpoints can be facilitated by videomail server 88, by call control mechanisms, or resolved by the endpoints themselves.

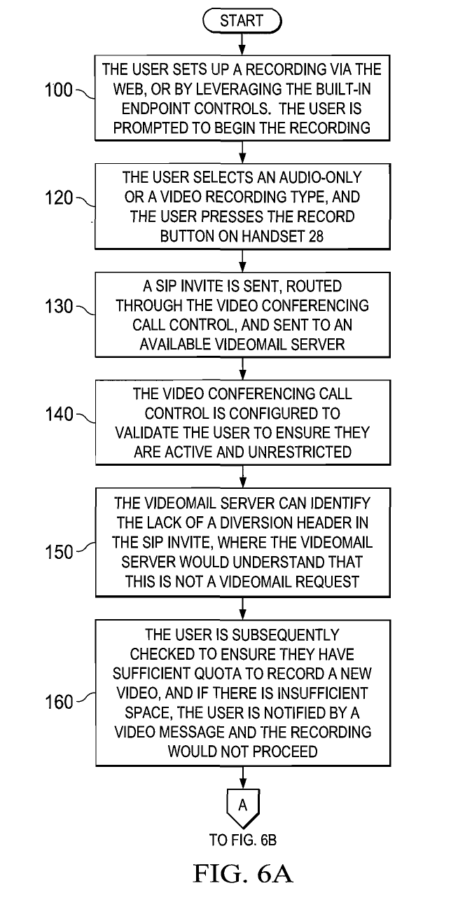

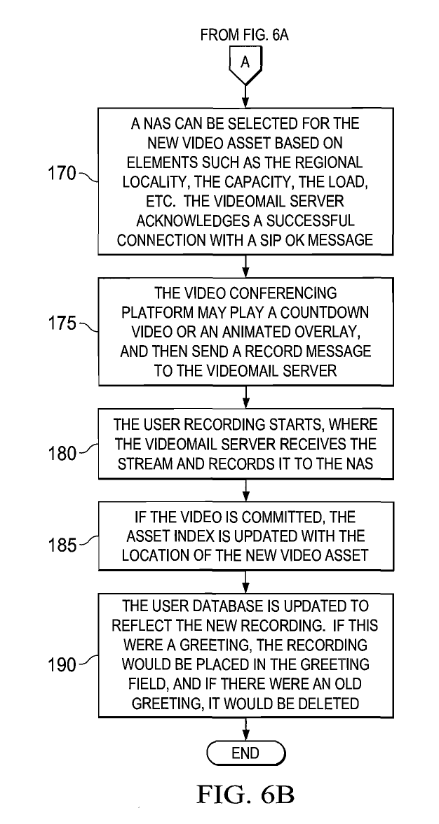

Referring now to some example use cases that can be executed by the videomail system, FIGS. 6A-6B are simplified flowcharts illustrating one example scenario involving the user making a recording (or recording a suitable greeting). This particular flow may begin at step 100, where the user sets up a recording via the web (or by leveraging the built-in endpoint controls). If the recording is initiated using the web, the videoconferencing platform (e.g., as shown in FIG. 1) is notified with the information, where an on-screen message indicates a readiness to record. In either event, the user is prompted to begin the recording.

At step 120, the user selects an audio-only or a video recording type, and the user presses the record button on handset 28. At step 130, a SIP INVITE is sent, routed through the videoconferencing call control (e.g., through a SIP ACE processor blade), and delivered to an available videomail server 88. At step 140, the video conferencing call control is configured to validate the user to ensure they are active and unrestricted (e.g., does not owe money). If the user is invalid, the user is directed to a recording indicating the problem, where an error may be logged and/or sent to administrators. If the user were validated, then the request would be forwarded on to videomail server 88.

At step 150, videomail server 88 can identify the lack of a diversion header in the SIP INVITE, where videomail server 88 would understand that this is not a videomail request. At step 160, the user is subsequently checked to ensure they have sufficient quota to record a new video, and if there is insufficient space, the user is notified by a video message and the recording would not proceed. A NAS can be selected for the new video asset based on elements such as the regional locality, the capacity, the current load, etc. If the NAS space were unavailable, the user would be redirected to a failure message. Otherwise, videomail server 88 acknowledges a successful connection with a SIP OK message, as shown by step 170.

At step 175, the videoconferencing platform may play a countdown video or an animated overlay, and then send a record message to videomail server 88. At step 180, the user recording starts, where videomail server 88 receives the stream and records it to the NAS. When the user is finished or during the recording, suitable UI controls provide the ability to stop, quit, replay, redo, or commit to the recorded video. At step 185, if the video is committed to, the Asset Index (that can be stored in any appropriate location, database, NAS, the user's videoconferencing endpoint, etc.) is updated with the location of the new video asset. At step 190, the user database is updated to reflect the new recording. If this were a greeting, the recording would be placed in the greeting field, and if there was an old greeting, it would be deleted. Both greetings and recordings can count against the user's allotted quota. The user can also be granted read/write access to the asset. At any time during a recording, if a call comes in, the videoconferencing platform can respond with a busy indication, where the incoming call would be diverted to video voicemail.

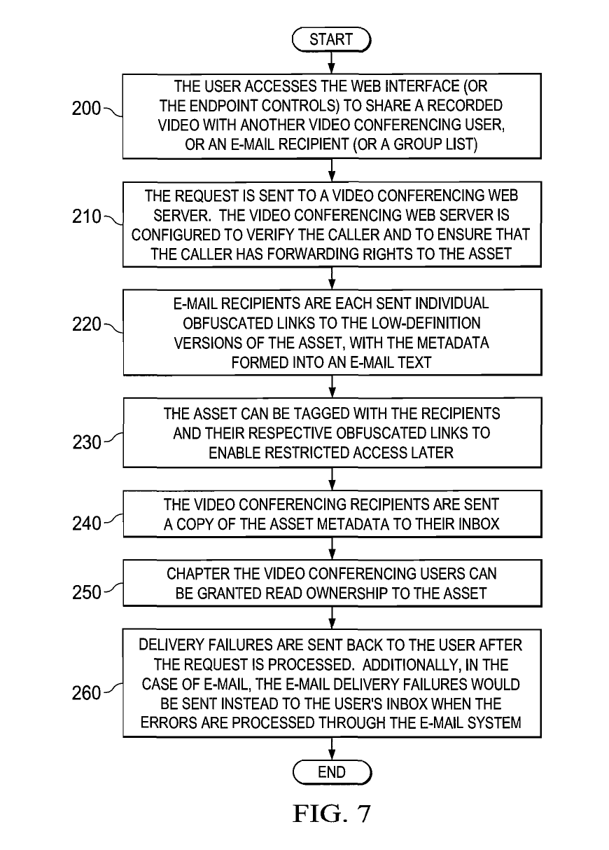

FIG. 7 is a simplified flowchart illustrating one operation associated with the user sharing (or forwarding) a video recording. This particular flow may begin at step 200, where the user accesses the web interface (or the endpoint controls) to share a recorded video with another videoconferencing user or email recipient (or a group list). At step 210, the request is sent to a videoconferencing Web server. The videoconferencing Web server is configured to verify the caller and to ensure that the caller has forwarding rights to the asset. The videoconferencing Web server (e.g., as illustrated in FIG. 5) can check videoconferencing recipients to ensure they have sufficient quota to receive a copy of the recording, and to make sure they also have not blacklisted the sender from sending videos to them.

At step 220, e-mail recipients are each sent individual obfuscated links to the low-definition (e.g., a common intermediate format (CIF)) versions of the asset, with the metadata formed into an email text. The formatting can be subject to an administrator (or a user) configuration. Obfuscation provides several features including the ability to view once only, to provide access only to the first playback IP address, the ability to cancel access to a particular recipient, etc. In one example, recipients are simple sent a uniform resource locator (URL) address used for viewing the video message. The asset can be tagged with the recipients and their respective obfuscated links to enable restricted access later. This is illustrated by step 230. The videoconferencing recipients are sent a copy of the asset metadata to their Inbox at step 240. Subsequently, the videoconferencing users can be granted “read ownership” to the asset, but only if they do not have it already (i.e., the architecture can be configured to check for existing ownership initially). This is illustrated by step 250. Afterward, message waiting indicators are updated, if required. At step 260, any possible delivery failures can be sent back to the user after the request is processed. Additionally, in the case of e-mail, the e-mail delivery failures would be sent instead to the user's Inbox when the errors are processed through the email system.

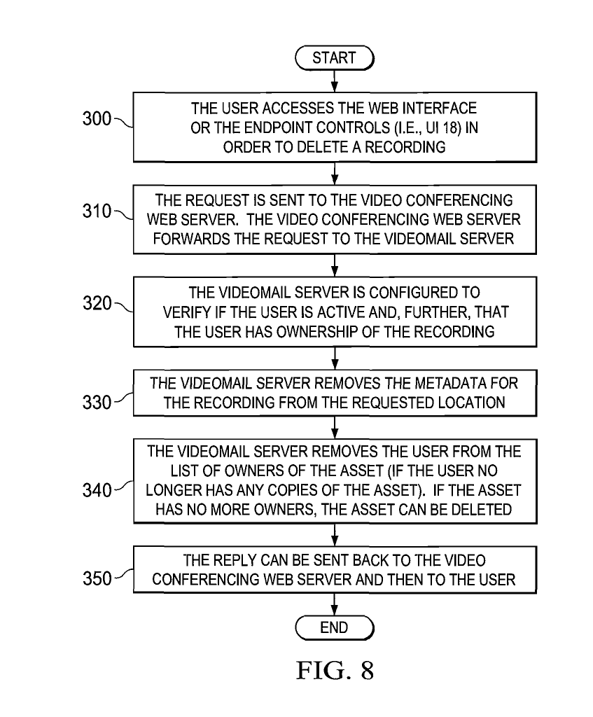

FIG. 8 is a simplified flowchart illustrating another use case, where this particular scenario addresses a user deleting a video recording. At step 300, the user accesses the web interface or the endpoint controls (i.e., UI 18) in order to delete a recording. At step 310, the request is sent to the videoconferencing Web server. The videoconferencing Web server forwards the request to videomail server 88. At step 320, videomail server 88 is configured to verify if the user is active and, further, that the user has ownership of the recording (Inbox, saved messages, gallery, etc.). At step 330, videomail server 88 removes the metadata for the recording from the requested location (Inbox, saved messages, gallery, etc.).

At step 340, videomail server 88 removes the user from the list of owners of the asset (if the user no longer has any copies of the asset). If the asset has no more owners, the asset can be deleted. Note that there could be an exception to this asset deletion. For example, if the asset is currently being played back via the Web, the asset can survive until the playback ends, or after a 30-minute expiration (or any other time parameter), or whichever event would end sooner. At step 350, the reply can be sent back to the videoconferencing Web server and then to the user.

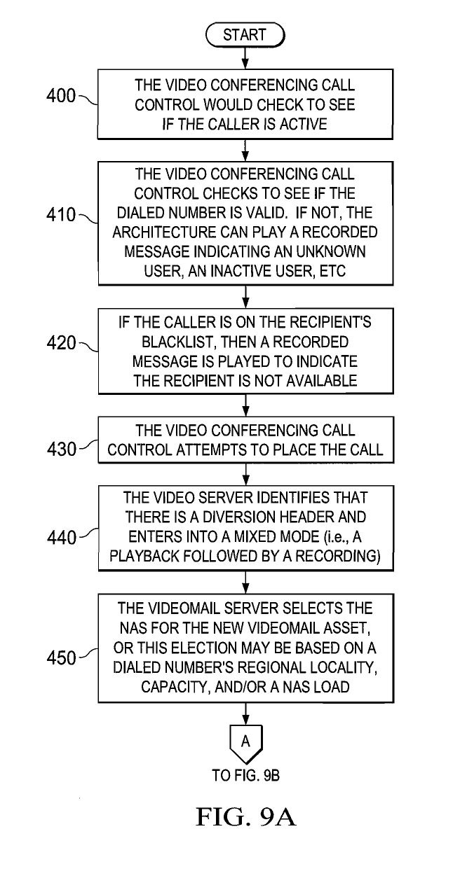

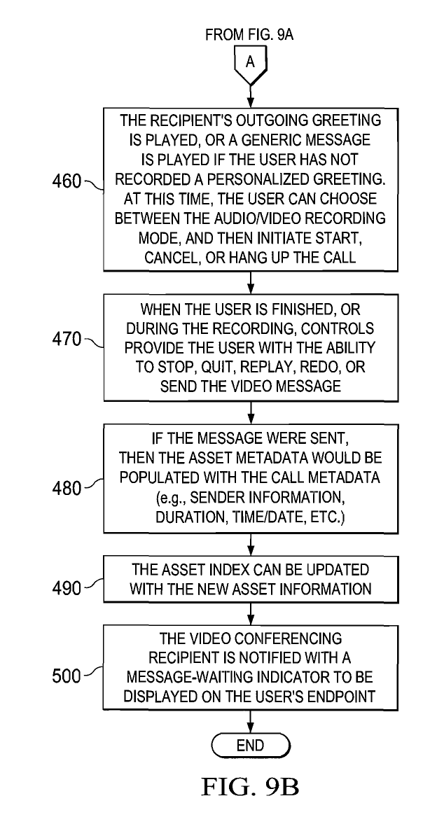

FIGS. 9A-9B are simplified flowcharts illustrating another use case, and this particular scenario addresses a caller leaving a videomail. The method may begin at step 400, where the video conferencing call control would check to see if the caller is active. If the caller were not active, the architecture would play a recorded message indicating “your station is not activated.” At step 410, the video conferencing call control checks to see if the dialed identifier string is valid (e.g., the videoconferencing number, an alphanumeric string, the user ID, a user object, etc.). If not, the architecture can play a recorded message indicating an unknown user, an inactive user, etc.

At step 420, if the caller is on the recipient's blacklist, then a recorded message is played to indicate the recipient is not available. Privacy settings can be accessed at this juncture in certain embodiments. Note that if the recipient is restricted (e.g., owes money) or if the recipient is over or near their quota, a recorded message can be played that indicates the user's mailbox is full. At step 430, the video conferencing call control attempts to place the call. If the recipient is not connected to the network (e.g., no RING), or is busy, or does not answer the call after a configured interval (e.g., number of rings), a diversion header is added to the SIP call, and forwarded to videomail server 88.

Video server 88 identifies that there is a diversion header and enters into a MIXED mode (i.e., a playback followed by a recording), which is shown by step 440. At step 450 videomail server 88 selects the NAS for the new videomail asset, or this election may be based on a dialed number's regional locality, capacity, and/or a NAS load. If no space were available, an error message would be played or displayed on the caller's endpoint. At step 460, the recipient's outgoing greeting is played, or a generic message is played if the user has not recorded a personalized greeting. At this time, the user can choose between the audio/video recording mode, and then initiate start, cancel, or hang up the call. In this particular instance, the user presses record, records the message, and the recorded message can be sent to videomail server 88. In this example, the caller's message is recorded and stored on the selected NAS.

At step 470, when the user is finished, or during the recording, controls provide the user with the ability to stop, quit, replay, redo, or send the video message. At step 480, if the message were sent, then the asset metadata would be populated with the call metadata (e.g., sender information, duration, time/date, etc.). The Asset Index can be updated with the new asset information at step 490. Also, the user database can be updated to reflect a new videomail in the callee's Inbox. Videomail would count against the callee's allotted quota in certain instances, or the videomail generation (in stores) may be based on specific types of accounts being configured for a given user. At step 500, the videoconferencing recipient is notified with a message waiting indicator to be displayed on the user's endpoint. At any time during leaving a videomail, if a call comes in, the calling videoconferencing endpoint can respond with a busy signal, where the incoming call is diverted to voicemail.

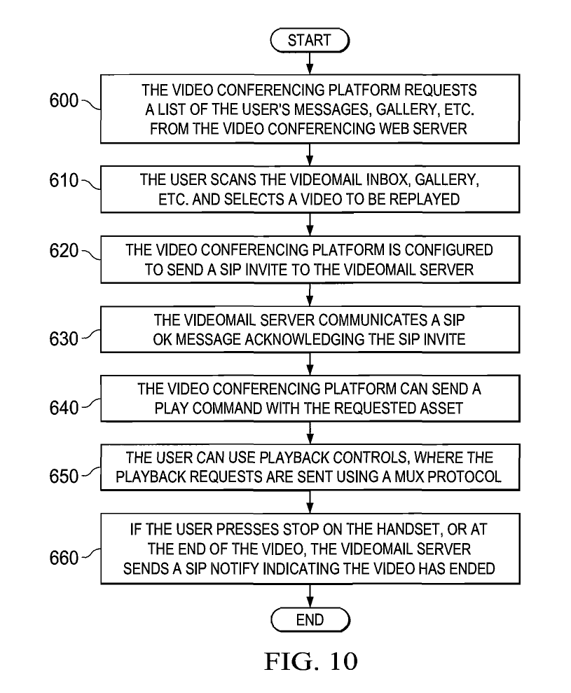

FIG. 10 is a simplified flowchart illustrating another use case associated with video messaging. This particular example of FIG. 10 is associated with the user retrieving videomail from the videoconferencing platform. The method may begin at step 600, where the videoconferencing platform requests a list of the user's messages, gallery, etc. from the videoconferencing Web server. At step 610, the user scans the videomail Inbox, gallery, etc. and selects a video to be replayed. At step 620, the videoconferencing platform is configured to send a SIP INVITE to videomail server 88. At step 630, videomail server 88 communicates a SIP OK message acknowledging the SIP INVITE. At step 640, the videoconferencing platform can send a PLAY command with the requested asset. At step 650, the user can use playback controls (e.g., Pause, Skip Forward, Skip Reverse, Stop, Play), where the playback requests can be sent using a MUX protocol (or any other appropriate mechanism).

If the user presses STOP on handset 28, or at the end of the video, videomail server 88 sends a SIP NOTIFY indicating the video has ended. This is reflected by step 660. Subsequently, the videoconferencing platform identifies this event and returns back to displaying the list of messages. At any time during a playback, if a call comes in, the videoconferencing platform responds with a busy signal, where the incoming call is diverted to voicemail. Message waiting indicators can be updated during the playback, where this protocol may be contrary to the behavior during a recording. It is imperative to note that the previously-discussed signaling, notifications, formatting, and/or protocols have only been earnestly offered for purposes of example. Any suitable permutations of these elements, or altogether different signaling, notifications, formatting, and/or protocols can be employed in order to achieve the activities discussed above. Any such changes are clearly within the broad scope of the present disclosure.

Note that in certain example implementations, the videomail management functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or any other similar machine, etc.). In some of these instances, a memory element [as shown in FIG. 5] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 5] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Note that videomail server 88 may share (or coordinate) certain processing operations. Using a similar rationale, its respective memory elements may store, maintain, and/or update data in any number of possible manners. In a general sense, the arrangements depicted in the preceding FIGURES may be more logical in their representations, whereas a physical architecture may include various permutations/combinations/hybrids of these elements. In one example implementation, videomail server 88 includes software (e.g., as part of the modules of FIG. 5) to achieve the videomail management operations, as outlined herein in this document. In other embodiments, these features may be provided externally to any of the aforementioned elements, or included in some other network element to achieve this intended functionality. Alternatively, several elements may include software (or reciprocating software) that can coordinate in order to achieve the operations, as outlined herein. In still other embodiments, any of the devices of the FIGURES may include any suitable algorithms, hardware, software, components, modules, interfaces, or objects that facilitate these switching operations.

In one example implementation, videomail server 88 is configured to include memory elements for storing information to be used in achieving the intelligent videomail management operations, as outlined herein. Additionally, videomail server 88 may include a processor that can execute software or an algorithm to perform the videomail management activities, as discussed in this Specification. As a related matter, a videoconferencing endpoint may include similar infrastructure (e.g., a processor and a memory element as shown) in order to provide various videomail services to an individual operating the videoconferencing platform. In such an instance, the videoconferencing endpoint (and/or equipment) may include enhanced intelligence, or increased capacity to handle the activities discussed herein at a more local level.

All of these devices may further keep information in any suitable memory element (e.g., random access memory (RAM), ROM, EPROM, EEPROM, ASIC, etc.), software, hardware, or in any other suitable component, device, element, or object where appropriate and based on particular needs. Any of the memory items discussed herein (e.g., database, table, key, queue, etc.) should be construed as being encompassed within the broad term ‘memory element.’ Similarly, any of the potential processing elements, modules, and machines described in this Specification should be construed as being encompassed within the broad term ‘processor.’ Console element 20 and/or videomail server 88 can also include suitable interfaces for receiving, transmitting, and/or otherwise communicating data or information in a network environment.

Note that with the examples provided herein, interaction may be described in terms of two, three, or four elements. However, this has been done for purposes of clarity and example only. In certain cases, it may be easier to describe one or more of the functionalities of a given set of flows by only referencing a limited number of elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain server components, system 10 may be applicable to other protocols and arrangements (e.g., those involving any type of videoconferencing scenarios). Additionally, although camera element 14 has been described as being mounted in a particular fashion, camera element 14 could be mounted in any suitable manner in order to suitably capture video images. Other configurations could include suitable wall mountings, aisle mountings, furniture mountings, cabinet mountings, upright (standing) assemblies, etc., or arrangements in which cameras would be appropriately spaced or positioned to perform its functions.

Furthermore, the users described herein are simply individuals within the proximity, or within the field of view, of display 12. Audience members can be persons engaged in a video conference involving other individuals at a remote site. Audience members can be associated with corporate scenarios, consumer scenarios, residential scenarios, etc. or associated with any other suitable environment to which system 10 may be applicable.

Additionally, system 10 can involve different types of counterparties, where there can be asymmetry in the technologies being employed by the individuals. For example, one user may be using a laptop, while another user is using the architecture of system 10. Similarly, a smartphone could be used as one individual endpoint, while another user continues to use the architecture of system 10. Also, Webcams can readily be used in conjunction with system 10. Along similar lines, multiparty calls can readily be achieved using the teachings of the present disclosure. Moreover, although system 10 has been illustrated with reference to particular elements and operations that facilitate the communication process, these elements and operations may be replaced by any suitable architecture or process that achieves the intended functionality of system 10.

What is claimed is:

1. A method, comprising:
receiving a request to establish a video session between a first user and a second user, wherein the request is sent by the second user by dialing an identifier string associated with the first user;
evaluating whether the first user has accepted the request, wherein if the first user has not accepted the request over a designated interval, then the second user is directed to an element configured for recording a videomail message for access by the first user;
identifying the first user has accepted the request; and
establishing the video session between the first user and the second user.

2. The method of claim 1, wherein the video session is rendered on a display that is configured to concurrently display television programming for the first user.

3. The method of claim 1, further comprising:
initiating a particular call to a particular user, wherein the first user initiates the particular call using a smartphone, and wherein the particular call is transitioned to a particular video session on a display configured to concurrently display television programming for the first user.

4. The method of claim 1, wherein privacy settings are accessed in order to determine whether to establish the video session between the first user and the second user.

5. The method of claim 1, further comprising:
recording a video message;
selecting a particular identifier string associated with a particular user; and
communicating the video message to a destination associated with the particular user.

6. The method of claim 5, wherein the destination is a uniform resource locator (URL) address.

7. The method of claim 5, wherein the destination is a Webcam associated with a particular user.

8. Logic encoded in one or more tangible media that includes code for execution and when executed by a processor operable to perform operations comprising:
receiving a request to establish a video session between a first user and a second user, wherein the request is sent by the second user by dialing an identifier string associated with the first user;
evaluating whether the first user has accepted the request, wherein if the first user has not accepted the request over a designated interval, then the second user is directed to an element configured for recording a videomail message for access by the first user;
identifying the first user has accepted the request; and
establishing the video session between the first user and the second user.

9. The logic of claim 8, wherein the video session is rendered on a display that is configured to concurrently display television programming for the first user.

10. The logic of claim 8, the operations further comprising:
initiating a particular call to a particular user, wherein the first user initiates the particular call using a smartphone, and wherein the particular call is transitioned to a particular video session on a display configured to concurrently display television programming for the first user.

11. The logic of claim 8, wherein privacy settings are accessed in order to determine whether to establish the video session between the first user and the second user.

12. The logic of claim 8, the operations further comprising:
recording a video message;
selecting a particular identifier string associated with a particular user; and
communicating the video message to a destination associated with the particular user.

13. The logic of claim 8, wherein the destination is a Webcam associated with a particular user.

14. An apparatus, comprising:
a memory element configured to store data; and
a processor operable to execute instructions associated with the data, wherein the processor and the memory element cooperate such that the apparatus is configured to:
receive a request to establish a video session between a first user and a second user, wherein the request is sent by the second user by dialing an identifier string associated with the first user;
evaluate whether the first user has accepted the request, wherein if the first user has not accepted the request over a designated interval, then the second user is directed to an element configured for recording a videomail message for access by the first user;
identify the first user has accepted the request; and
establish the video session between the first user and the second user.

15. The apparatus of claim 14, wherein the video session is rendered on a display that is configured to concurrently display television programming for the first user.

16. The apparatus of claim 14, wherein the apparatus is further configured to:
initiate a particular call to a particular user, wherein the first user initiates the particular call using a smartphone, and wherein the particular call is transitioned to a particular video session on a display configured to concurrently display television programming for the first user.

17. The apparatus of claim 14, wherein privacy settings are accessed in order to determine whether to establish the video session between the first user and the second user.

18. The apparatus of claim 14, wherein the apparatus is further configured to:
record a video message;
select a particular identifier string associated with a particular user; and
communicate the video message to a destination associated with the particular user.

19. The apparatus of claim 14, further comprising:
a console element configured to interface with a display for rendering images associated with the video session.

20. The apparatus of claim 14, when the destination is a Webcam associated with a particular user.
